(19) United States
(12) Patent Application Publication
(10) Pub. No.: US 2011/0072036 A1
(43) Pub. Date: Mar. 24, 2011

(54) PAGE-BASED CONTENT STORAGE SYSTEM

(75) Inventors: Mohsen Agsen, Honolulu, HI (US); Georg Petschnigg, Seattle, WA (US); Yasser Asmi, Redmond, WA (US); Justin Goshi, Honolulu, HI (US)

(73) Assignee: MICROSOFT CORPORATION, Redmond, WA (US)

(21) Appl. No.: 12/694,962

(22) Filed: Jan. 27, 2010

Related U.S. Application Data
(60) Provisional application No. 61/245,247, filed on Sep. 23, 2009.

(51) Int. Cl. G06F 3/048; G06F 17/30; G06F 3/041

(52) U.S. Cl. 707/769; 715/776; 345/173; 707/E17.014

(57) ABSTRACT

A page-based content storage system may be provided by a method of managing content which includes generating, from a plurality of electronic files containing displayable content, a plurality of viewpages, where each viewpage contains one or more portions of the displayable content and each viewpage is displayable in a single-page view. The method further includes assembling the viewpages into a journal to provide a page-based storage structure configured to enable individual, selective management of the viewpages based on properties associated with the one or more portions of the displayable content. The method further includes visually presenting the viewpages as single-page views accessible via a page-based user interface of a computing system.

### CROSS REFERENCE TO RELATED APPLICATIONS

This application claims priority to U.S. App. Ser. No. 61/245,247, filed Sep. 23, 2009, the entirety of which is hereby incorporated herein by reference.

### BACKGROUND

In today's multimedia computing environment, users typically store content in a variety of different file types on their computing devices. For example, a user may store images, fixed document format files, word processing files, etc., in a file system of a computing device. Although use of different file types can enhance the user's computing experience, there are drawbacks with current methods of interacting with these different file types. For example, one drawback with the storage of files of different file types is that the user typically employs a variety of different application programs to view and otherwise interact with the different file types. Transitioning between these different application programs can be cumbersome, and a user can lose his or her bearings in the midst of projects involving a large number of files. Should the user desire to view content from different specific locations in the different files, the user often resorts to printing out the different files using the different application programs, selecting the desired printed pages, and stapling the result together, for example, to bring on a business trip or vacation. Other users might employ a publishing program that enables the user to aggregate and arrange content from the various files by cutting-and-pasting selected content into a new publishing document; however, such an approach is complicated and time consuming, and can lead to broken links to the original source files. Finally, another drawback is that file names (e.g. IMG_{—}324.JPG or Document1.Docx) are often insufficient in capturing a file's content, thus complicating file document retrieval. As a result, the user experience interacting with content from files of different file types can be fragmented and disorienting, potentially reducing user productivity and stifling creativity.

### SUMMARY

Various embodiments related to a page-based content storage system are disclosed herein. According to one aspect of this disclosure, a page-based content storage system may be provided including a method of managing content. The method may include generating, from a plurality of electronic files containing displayable content, a plurality of viewpages, where each viewpage contains one or more portions of the displayable content and each viewpage is displayable in a single-page view. The method further includes assembling the viewpages into a journal to provide a page-based storage structure which enables individual, selective management of the viewpages based on properties of the displayable content. The method further includes visually presenting the viewpages as single-page views accessible via a page-based user interface.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows accessing content via an example page-based content storage system.

FIG. 2 schematically shows importing content into an example page-based content storage system.

FIG. 3 shows a box diagram of an example computing device having an example page-based content storage system.

FIG. 4 shows a flow diagram of an example method of managing content in accordance with an embodiment of the present disclosure.

### DETAILED DESCRIPTION

Traditional file systems can impose artificial boundaries on the files stored in the system. Such boundaries may include file-formats, documents, operating systems and other boundaries which can impede the ability to efficiently and intuitively access and interact with the content contained in the files of interest. For example, a user may view files in such a system based on a file name or a file type, which may not actually indicate the content of the file to the user. Thus, a user may have to open several applications to view a variety of files when searching for a particular piece of content. Therefore, a page-based content storage system as described herein may provide a more intuitive environment for utilizing, organizing and storing content from a variety of sources. Such a system may create a more immediate user experience in connection with storing and retrieving digital information. Rather than exposing a user to file and document types, a page-based content storage system presents a user with a storage model that is based on viewpages generated from an electronic source file.

As explained in more detail below, a viewpage contains one or more portions of displayable content from an electronic source file, and each viewpage is displayable in a single-page view. As such, a viewpage can typically be displayed on a display screen of a device having a notebook-like form factor. The viewpages may be accessed, edited, sorted, reorganized, grouped, etc. In this way, end-users have direct access to the content by way of the viewpages, across application and file types, as described in detail below in connection with various examples.

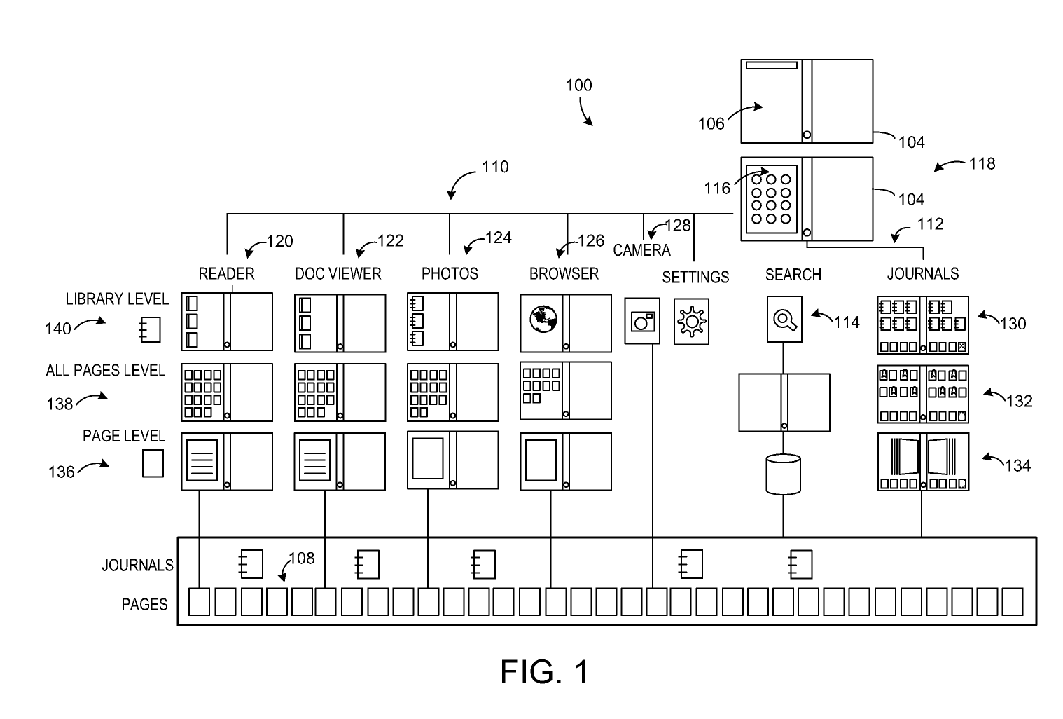

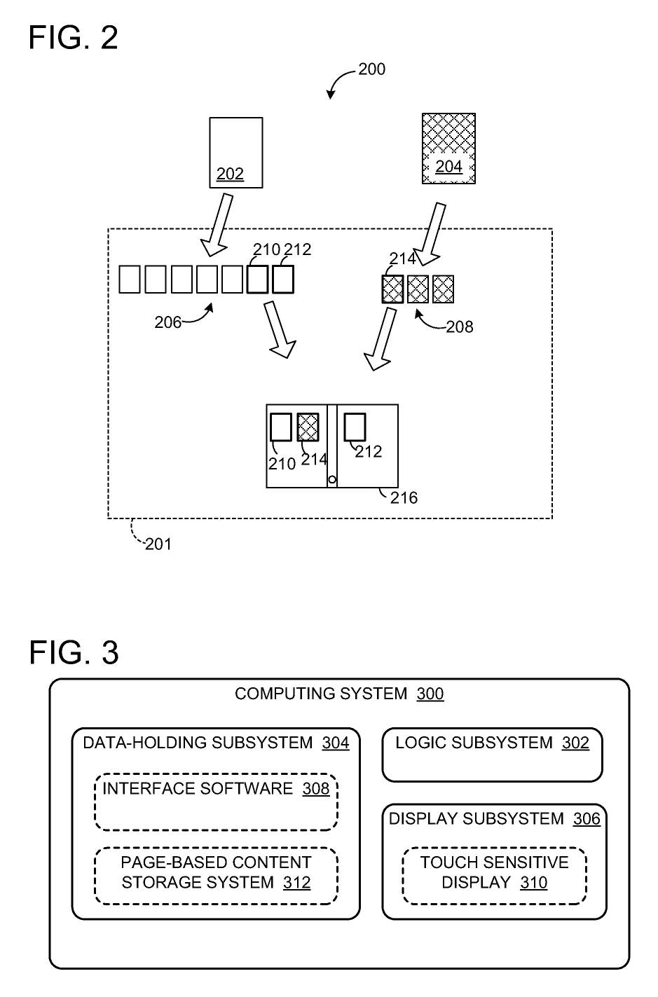

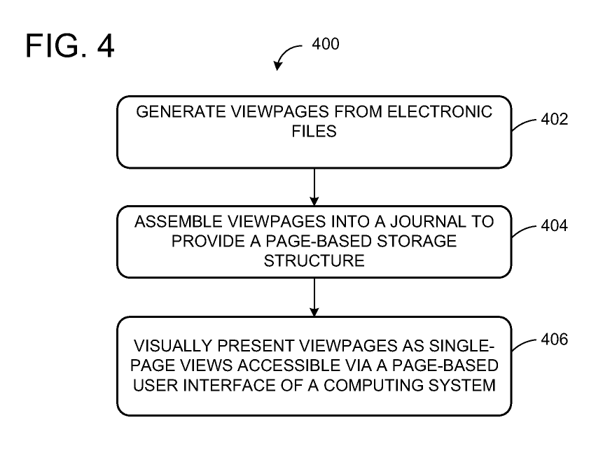

FIG. 1 schematically shows, at 100, accessing content via an example page-based content storage system. Such a system may be implemented on any suitable computing device. Examples of suitable computing devices include, but are not limited to, personal computing devices, handheld computing devices, personal digital assistants, televisions, mobile devices and the like. In some cases, the information that is consumed by the computing device may be served from a network-accessible cloud computing device. Further, the computing device may be a touch sensitive computing device as described in more detail with reference to FIG. 3. As will be described in more detail with reference to FIGS. 2 and 4, content may be imported into such a file storage system from various electronic files, and stored as “viewpages.” These viewpages can then be organized, aggregated, etc., for optimized viewing, as described hereafter.

FIG. 1 shows an example computing device 104 configured to utilize such a page-based content storage system for managing content. As briefly introduced above, the computing device may be configured to break up the content of various electronic files into a plurality of viewpages 108 which can then be accessed via viewers, organized into journals, edited, managed, manipulated, resequenced, sorted, etc.

A journal typically includes a plurality of viewpages and thus provides a page-based storage structure for the viewpages. In some embodiments, the journal/collection of viewpages and can be utilized in a similar manner to that of a physical journal. For example, the journal may be configured as a virtual book capable of sequentially displaying the viewpages within the journal. As such, the viewpages assembled into the journal can be accessible and reorganizable within the journal. Journals may have different attributes based on how the viewpages are presented, based on the content of the viewpages, and/or various other attributes assigned by the page-based content storage system and/or by a user.

As such, a journal may provide homogenous views of viewpages by displaying viewpages having a shared property, such as a same content type (e.g., all photo viewpages), a same source (e.g., all viewpages from File A), a same date (e.g., all viewpages created last Monday), and the like. Alternatively, a journal may provide heterogeneous views of viewpages by displaying viewpages having disparate properties. As an example, a journal may include viewpages corresponding to a budget spreadsheet, account statements, bills, and images of future large-purchase items for which the user is saving money. As another example, a journal may include viewpages corresponding to photos of the user's dog, vet bills, and a list of dog-sitting contacts. As yet another example, a journal may include viewpages corresponding to photos of an event hall, a guest list, a caterer's menu and driving directions. It can be appreciated that the journal examples described herein are illustrative and nonlimiting in that viewpages may be grouped within a journal in virtually any number of various ways.

Further, in addition to displayable content, various metadata and information may be associated with each viewpage. This “meta information” may include a type of content being displayed, keywords, a source electronic file name, user inputs, and the like. Such metainformation may be utilized when searching the viewpages.

As such, a page-based content storage system is distinct from a conventional electronic file-based system, in that the viewpages provide the basic unit of storage as opposed to files. Further, journals are distinct from traditional clipboards, etc. in that the viewpages within a journal remain editable, searchable, etc. and can remain linked to their source electronic files, as described in more detail as follows.

Since each viewpage contains a selected portion or portions of content, a user may easily compile just the content that the user wants, such as a paragraph from a large document, a photo from a photo album, a paragraph of information from a website, etc. As such, viewpages provide the basic unit of storage within the page-based storage system described herein. In some cases, the viewpages can be created from electronic files that are generated based on events such as viewing a webpage, taking a photograph, querying databases, etc. In addition to containing displayable content, each viewpage may be implemented so as to include a link (e.g., hyperlink, pointer, reference, other mechanism) from the content to the original electronic file, and thus the content of the viewpage remains editable and searchable unlike static images produced by traditional clipping or snapshot tools. In one example, activating a link may allow access to the entire electronic file associated with the viewpage containing the link. As another example, activating a link may allow access to just the portion of content of the electronic file displayed by the viewpage. Further, the viewpages may later be recombined back into an electronic file having a traditional file format.

In one example, a word processing document could be broken up into a plurality of viewpages, where each page in the underlying word processing file yields a corresponding viewpage that becomes individually accessible via the page-based regime described herein. Thus, the content in the word processing document becomes accessible, viewable, editable, etc. through access to the individual viewpages formed from the underlying file. It can be appreciated that this example illustrates one of a variety of ways of generating viewpages. In other examples, a viewpage may correspond to half of a page of the original document, two pages of the original document, or nearly any other portion of the original document. In general it should be understood that electronic files (or portions thereof) may be broken up and/or combined in nearly limitless ways to create the viewpages described herein.

In some cases, viewpages may be generated, modified, accessed etc. based on user-based inputs received from the page-based user interface. In other cases, such actions may be initiated by the page-based storage system and/or a software application. As another example, viewpages may be generated and/or recombined back into an electronic file in response to a server request, such as, for example, when a user requests that a journal be exported on a webpage. These and other examples will be described in more detail below.

Computing device 104 may be configured to utilize the page-based content storage system in any suitable manner. One such suitable approach includes a method 400 of managing content, as illustrated in FIG. 4. At 402, method 400 includes generating, from a plurality of electronic files containing displayable content, a plurality of viewpages. Examples of such electronic files from which the viewpages are generated include, but are not limited to, word-processing documents, spreadsheets, presentations, databases, text files, drawing files, graphics files, photos, images, webpages, email messages, portable document format (PDF) files, and the like. As such, each viewpage contains one or more portions of the displayable content and each viewpage is displayable in a single-page view. In one embodiment, a viewer software application may be used to display viewpages, for example, on a device having a notebook-like form factor. Upon user-activation of an editing feature (e.g., a hyperlink), an alternate mode may be entered where content of the viewpage and/or the underlying electronic file associated with the viewpage can be edited. In some embodiments, edits may be performed in an original application corresponding to the electronic file (e.g., a spreadsheet program, photo editor, etc.)

In other words, the page-based content storage system allows the content of various files to be broken up into several portions which can then be contained within viewpages. As an example, a word-processing document may have 20 pages of text from which 20 viewpages may be generated, such that each viewpage contains content of a single page of the document. As another example, an electronic source file may include a webpage having text and images, and one viewpage may be generated that contains a paragraph of text from the webpage and another viewpage may be generated that contains an image from the webpage. As will be described in more detail hereafter, a user may access (e.g., view, edit, modify, reorganize, resequence, zoom, etc.) the viewpages and their associated portions of content using a page-based user interface which presents a visual presentation of the viewpages. Indeed, the viewpages and user interface allow the viewpages to become the mechanism by which the user interacts with the content, rather than the underlying file or files.

Continuing with FIG. 4, at 404, method 400 includes assembling the viewpages into a journal. Such a journal provides a page-based storage structure enabling individual, selective management of the viewpages. For example, the viewpages may be managed (edited, re-sequenced, searched, etc.) other than by conventional access of the underlying file. Such management may be based on properties of the displayable content. In other words, although various viewpages can be associated with portions of content of various types, the viewpages may be managed, sorted, displayed, aggregated, searched, etc. based on properties of the content associated with each viewpage. Nonlimiting examples of such properties include keywords, content type, tags, metadata, subject, author, title, and the like.

By assembling the viewpages into a journal, the journal functions as a container for viewpages. The viewpages assembled into the journal are reorganizable within the journal, in that viewpages may be moved to any page of the journal just as a clipping may be moved in a physical journal. Movement/re-sequencing of viewpages, or editing or other actions affecting viewpages, may or may not result in changes to the underlying file.

At 406, method 400 includes visually presenting the viewpages as single-page views accessible via a page-based user interface of a computing system. As such, the viewpages assembled into the journal are accessible and reorganizable within the journal via the page-based user interface. Such a page-based user interface may be displayed on a touch sensitive display of the computing device, and thus be configured to receive touch inputs from a user. As a nonlimiting example, a computing device may have interface software that is configured to detect a touch input applied to a touch sensitive display and, in response to such detection, display a touch operable page-based user interface.

In one example, the computing device may is implemented to have a book- or notebook-like form factor, and is configured to recognize touch gestures corresponding to page controls of virtual pages visually presented on the display, such as virtually turning a page. In such a case, the journal may be configured as a virtual book capable of sequentially displaying the viewpages within the journal, so as to more closely mimic a physical journal. Regardless of the form factor of the computing device, the term “journal” as used herein refers to a collection of viewpages having certain characteristics. For example, the sequence of the viewpages is one characteristic of a journal of viewpages. In a sense, the journal operates as a data structure that is recognizable by the page-based user interface described herein. Among other things, the user interface recognizes the journal and causes a visual presentation of the viewpages such that each viewpage is presented as a single-page view. In the notebook-type form factor, each single-page view would be akin to a page of a physical notebook and typically would be sized to fill an entire one of the display screens of the device.

A user can interact with the viewpages via the page-based user interface to view, browse, edit, etc. viewpages such as illustrated in FIG. 1, wherein viewpages 108 may be accessed via viewers such as indicated at 110 or journals such as indicated at 112. As such, the page-based user interface facilitates use of the page-based content storage system to provide an intuitive environment for utilizing, organizing and storing content from a variety files. As will be described in more detail hereafter, the viewpages may be accessed for performing a variety of different viewpage operations, such as modifying the viewpages, searching the viewpages, converting the viewpages to known file formats, etc.

Thus, the page-based content storage system presents the “world” of files as a set of viewpages. As introduced above, viewpages may contain written notes, clipped content, photos, text, images, etc. As such, a page-based content storage system provides a user-visible storage concept. Unlike desktop operating systems, the page-based content storage system typically does not expose the viewpage file name to the user. Rather, viewpage names may be automatically generated by the system, may be globally unique, and may be displayed as visual thumbnails for identification. Further, the page-based content storage system may save viewpages inside associated folders in the electronic file system.

Moreover, the canonical, page-based format of the page-based content storage system allows for storing and displaying of page-based information such as documents, photos, websites, books, etc. and provides a variety of optimized views for accessing such information. For example, as illustrated in FIG. 1, a user may utilize a page-based user interface including a journal library 106 to access content from a variety of electronic files which have been imported into the page-based content storage system and stored as a plurality of viewpages 108. Thus, journal library 106 may be used to view viewpages from viewers, indicated at 110, that display homogenous views of journals having viewpages of a shared property (e.g., documents, photo albums, books, etc.).

As described above, journals within the page-based content storage system can be used as containers for grouping viewpages, and thus may serve as various albums, books, viewers, and the like. For example, a journal of the page-based content storage system may contain viewpages of written notes and clipped content. As another example, a journal in the form of a photo album may contain viewpages of photos. As yet another example, a journal in the form of an electronic book may contain viewpages of text and images. As yet another example, a journal in the form of a document may contain viewpages of document content. It can be appreciated that such journals may be created in any suitable manner, such as by the computing system, the page-based content storage system, an application, a user, etc.

Accordingly, a user may utilize journal library 106 to view viewpages from journals, indicated at 112, that display heterogeneous views of journals having viewpages of disparate properties. Further, the page-based content storage system includes a search function 114 which allows for searching across viewpages in homogenous and/or heterogeneous views. Such a search function may, for example, apply searching algorithms to the metainformation associated with the viewpages.

As an example use scenario, a user may have various files stored on a computing device relating to a vacation the user is planning For example, the user may gather websites (e.g., HTML files), scan in pages from a guide-book (e.g., TIF files), e-mail messages, photos (e.g., JPG files), airline tickets (e.g., PDF files), a to-do list (e.g., a TXT file), budgets (e.g., XLSX files) or itineraries (e.g., DOCX files). Traditionally, these files may be loosely stored in a folder wherein the filenames may insufficiently or incorrectly identify a file's content. Further, traditional viewing of the files may include opening them in disparate applications. Additionally, maintaining links to original source materials or links within materials may be poorly supported in traditional approaches, and aggregating and arranging the materials may require yet another application. Alternatively, the page-based content storage system allows the user to create viewpages from the content of the files and organize these viewpages into journals, akin to how a physical journal may be utilized. In the aforementioned example, the user may create a “vacation journal” to aggregate and view the heterogeneous information he has collected.

FIG. 2 schematically shows such an example possible use scenario. At 200, viewpages may be generated from electronic files by an example page-based content storage system 201. Viewpages may be generated in any suitable approach, such as automatically by the page-based content storage system, by a user, by an application, etc. For example, electronic file 202 and electronic file 204 each containing displayable content may be imported into a page-based content storage system. In some embodiments, the page-based content storage system may retain references to source files and links throughout a journal hierarchy of viewpages. In other embodiments, the page-based content storage system may duplicate content upon importing the content into the system. Upon import, electronic files 202 and 204 may each be represented as a plurality of viewpages 206 and 208, respectively. Various viewpages may then be selected, namely viewpages 210, 212 and 214, to be grouped into a journal 216. Such selection may be made by a user, the page-based content storage system, an application, and the like.

Returning to FIG. 1, journal library 106 may display a page-based user interface by which a user may select to view an application tray 116 as shown at 118. Application tray 116 may allow a user to select an “access point” for accessing viewpages, such as viewing viewpages in a homogenous view, via reader 120, document viewer 122, photo viewer 124, internet browser 126, camera 128, etc. Such views are homogeneous in that they display a collection of viewpages having a shared property. Additionally, application tray 116 may allow a user to select an access point for viewing viewpages in a heterogeneous view, such as journal viewer 130, light table viewer 132 and butterfly viewer 134. Such views are heterogeneous in that they display a collection of viewpages having disparate properties. These views will be described in more detail as follows.

As described above, the page-based content storage system may group viewpages via a container such as a journal. In some embodiments, a user may not see the actual journal, but rather sees an application-specific perspective on what a journal is. For example, journals may be used to represent collections of viewpages in a variety of forms such as photo albums, documents, books, etc. As such, each of these serves as a container of viewpages. A library application may be used, for example by journal library 106, to allow the user to select a journal. As such, the user may preview viewpages with the journal and may activate the appropriate application on the right page. It will be appreciated that the viewpages and journals represent a virtual file system employed by the page-based content storage system and that the contents of the viewpages and journals are stored on an actual file system that is managed by the operating system of the computing device. In some embodiments, such a virtual file system for viewpages may act as a “meta” file system that exists in parallel with the conventional file system for electronic files. Thus, in some embodiments, creation of viewpages may duplicate content of electronic files rather than modifying electronic files. The virtual file system may then identify viewpages based on the metainformation associated with each viewpage. In some cases, viewpages may be named, indexed and/or otherwise identified by the page-based content storage system. Viewpages may also have user-defined identification, such as titles, tags, keywords, and the like.

Continuing with FIG. 1, a user may view a variety of journals using journal viewer 130, each journal containing a variety of content represented as viewpages. Additionally or alternatively, a user may view pages of journals using light table viewer 132, similar to how a physical light table may be used. Further, a user may view pages of journals in the butterfly viewer 134 which displays viewpages similar to how a traditional book journal may be used.

The page-based content storage system displays homogenous views of viewpages via content-specific viewers as indicated at 110. Such views are homogeneous in that they display a collection of viewpages having displayable content with a shared property. These content-specific viewers may not only display viewpages at a single page level as indicated at 136, but may also display viewpages at an “all viewpages” level as indicated at 138 and/or at a library level as indicated at 140. For example, reader 120 may display a single viewpage of a book, multiple viewpages from a book, or a directory of books in which viewpages have been grouped. Similarly, document viewer 122 may display a single viewpage of a document, multiple viewpages from a document, or a directory of documents in which viewpages have been grouped. As another example, photo viewer 124 may display a single viewpage having a photo, multiple viewpages having photos, or a directory of photo albums in which viewpages having photos have been grouped. As yet another example, internet browser 126 may display a single viewpage having a webpage, multiple viewpages having webpages, or a menu providing options to open websites, view favorite websites, view a history of websites, view clippings from websites, etc.

Viewpages may be accessed and/or assembled in various manners, as described above. Thus, managing the viewpages by a method such as method 400 may further include accessing the viewpages in response to a touch input received via the page-based user interface. As an example, an editing input may be received via the page-based user interface, and in response, an application may be launched on the computing system for editing the viewpage within the journal. As another example, viewpages and/or the displayable content of such viewpages may be searched based on a search input received via the page-based user interface. Such searching may be done in any suitable manner, such as by using a search index.

As yet another example, viewpages may be resequenced within the journal in response to inputs received via the page-based user interface. In such a case, a viewpage's location within the journal may be changed, thus changing where within the journal the viewpage is visually presented. As yet another example, display views of viewpages may be adjusted within the journal in response to inputs received via the page-based user interface. Further, viewpages may be converted from their page-based storage format to a known electronic file format. For example, upon creating a journal, a user may decide to convert the journal to known file format, such as a PDF format.

From a storage perspective, the page-based content storage system may store viewpages within a page-based storage structure. In some embodiments, the page-based content storage system may use a globally unique identifier (GUID) without a file extension for each viewpage. Storing the viewpages via the page-based storage structure may include creating a file system folder for each application (e.g., using the application name as a folder name). Nested inside the application root folder may be a set of folders which contain the viewpages. These folders can appear to the user as journals, books, . . . etc. Applications can indicate that they have a single folder in which case the system creates a “Default” folder to be used.

The page-based content storage system may further include a viewpage indexing system. In such a system, each folder may contain a single file (e.g., INDEX.DAT file). Such a file may then contain a list of viewpage file names, for example, in a viewpage number order. As such, a viewpage position inside the file may determine its viewpage number. In some embodiments, no information may be saved in the viewpage file itself, to allow efficient insertion of viewpages as well as bulk deletion of viewpages. A file such as an INDEX.DAT file may include a version signature, followed by a simple list of viewpage file names, for example, separated by line termination. A nonlimiting example of an INDEX.DAT file is provided as follows:

C1.0

{A274B257-97FD-4980-AA2A-55A2AC9EC841}

{6E1D5114-BDB9-4D60-B788-E13404600F26}

{3C038846-5800-4107-8F32-8B8F929389FA}

. . .

The viewpage index file may be kept in memory and may be overridden when the application is deactivated or if the shell is shutdown. In some embodiments, the page-based content storage system may further include a timer-based checkpoint system to ensure that the viewpage index is saved periodically. Further, some embodiments of the page-based content storage system may include a storage disaster recovery system configured to reconstruct the viewpage index from the folder by scanning the file system files in created date order.

As shown at search function 114, a user may search for content viewable in the content specific viewers and/or in the journal viewers. Such a search index may be further configured to aggregate views of viewpages.

In some embodiments, the page-based content storage system may render known file types into individual viewpages as a bitmap and may organize the viewpages into journals. The page-based content storage system may be further configured to recombine viewpages and convert them into common file formats such as HTML, PDF, TIF, JNT, DOCX and others

FIG. 3 schematically illustrates a suitable computing device 300 on which the embodiments described herein may be implemented, including a logic subsystem 302 such as a processor, a data-holding subsystem 304, such as volatile and non-volatile memory, and a display subsystem 306. Programs to implement the embodiments described herein, such as interface software 308, may be stored in the data holding subsystem 304 and executed via the logic subsystem 302, and the output may be displayed on a display of the display subsystem 306 such as touch sensitive display 310. As such, computing device 300 can implement page-based content storage system 312. Various user input devices such as a mouse, keyboard, touch screen, may be coupled to the computing system to provide user input. Other suitable computing devices on which the embodiments described herein may be implemented are described in co-pending U.S. application Ser. No. 12/410,303, entitled DUAL SCREEN PORTABLE TOUCH SENSITIVE COMPUTING SYSTEM, filed Mar. 24, 2009, and Ser. No. 12/410,311, entitled BIMODAL TOUCH SENSITIVE DIGITAL NOTEBOOK, filed Mar. 24, 2009, the entire disclosures of each of which are herein incorporated by reference.

It will be appreciated that the computing devices described herein may be any suitable computing device configured to execute the programs described herein. For example, the computing devices may be a mainframe computer, personal computer, laptop computer, portable data assistant (PDA), computer-enabled wireless telephone, networked computing device, or other suitable computing device, and may be connected to each other via computer networks, such as the Internet. These computing devices typically include a processor and associated volatile and non-volatile memory, and are configured to execute programs stored in non-volatile memory using portions of volatile memory and the processor. As used herein, the term “program” refers to software or firmware components that may be executed by, or utilized by, one or more computing devices described herein, and is meant to encompass individual or groups of executable files, data files, libraries, drivers, scripts, database records, etc. It will be appreciated that computer-readable media may be provided having program instructions stored thereon, which upon execution by a computing device, cause the computing device to execute the methods described above and cause operation of the systems described above.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. In a page-based content storage system, a method of managing content, the method comprising:
generating, from a plurality of electronic files containing displayable content, a plurality of viewpages, each viewpage containing one or more portions of the displayable content and each viewpage being displayable in a single-page view;
assembling the plurality of viewpages into a journal to provide a page-based storage structure configured to enable individual, selective management of the plurality of viewpages based on properties of the displayable content; and
visually presenting the plurality of viewpages as single-page views accessible via a page-based user interface of a computing system.

2. The method of claim 1, wherein the journal is configured as a virtual book capable of sequentially displaying the plurality of viewpages within the journal, the plurality of viewpages assembled into the journal being accessible and reorganizable within the journal via the page-based user interface.

3. The method of claim 1, further comprising producing a homogeneous content display collection for viewpages having displayable content with a shared property.

4. The method of claim 1, further comprising producing a heterogeneous content display collection for viewpages having disparate properties.

5. The method of claim 1, further comprising modifying the one or more portions of the displayable content of a selected one of the plurality of viewpages based on input received via the page-based user interface of the computing system.

6. The method of claim 5, wherein modifying the one or more portions of the displayable content of the selected one of the plurality of viewpages includes launching an application on the computing system.

7. The method of claim 1, further comprising searching the displayable content of the plurality of viewpages based on a search index.

8. The method of claim 1, wherein generating the plurality of viewpages includes maintaining for each portion of the displayable content a link to the electronic file associated with that portion of the displayable content.

9. The method of claim 1, further comprising converting the plurality of viewpages from their page-based storage format to a known electronic file format.

10. The method of claim 1, wherein the computing system includes a touch sensitive computing system.

11. In a page-based content storage system, a method of managing heterogeneous displayable content via a page-based storage structure provided by a journal, the method comprising:
assembling into the journal a plurality of viewpages generated from a plurality of electronic files containing displayable content of various types, each viewpage containing one or more portions of the displayable content;
using a page-based user interface to visually present the journal so that each of the plurality of viewpages is displayed as a single-page view;
receiving a touch input via the page-based user interface, the touch input being directed toward a selected one of the plurality of viewpages; and
accessing the selected one of the plurality of viewpages based on the touch input.

12. The method of claim 11, wherein the journal is configured as a virtual book capable of sequentially displaying the plurality of viewpages within the journal, the plurality of viewpages assembled into the journal being accessible and reorganizable within the journal via the page-based user interface.

13. The method of claim 11, wherein accessing the selected one of the plurality of viewpages includes modifying the one or more portions of the displayable content of the selected one of the plurality of viewpages.

14. The method of claim 13, further comprising launching an application for editing within the journal the one or more portions of the displayable content of the selected one of the plurality of viewpages.

15. The method of claim 11, wherein accessing the selected one of the plurality of viewpages includes resequencing the selected one of the plurality of viewpages within the journal.

16. The method of claim 11, wherein accessing the selected one of the plurality of viewpages includes changing a display view of the selected one of the plurality of viewpages within the journal.

17. The method of claim 11, wherein each of the one or more portions of displayable content of each viewpage has a link to the electronic file from which the viewpage was generated.

18. A touch sensitive computing system, comprising:
a touch sensitive display;
a page-based content storage system; and
interface software operatively coupled with the touch sensitive display and the page-based content storage system,
where the interface software is configured to detect a touch input applied to the touch sensitive display and, in response to such detection, display a touch operable page-based user interface, the interface software being further configured to:
generate, from a plurality of electronic files containing displayable content, a plurality of viewpages, each viewpage containing one or more portions of the displayable content and each viewpage being displayable in a single-page view;
assemble the plurality of viewpages into a journal to provide a page-based storage structure configured to enable individual, selective management of the plurality of viewpages based on properties of the displayable content; and
visually present the plurality of viewpages as single-page views accessible via a page-based user interface of a computing system.

19. The touch sensitive computing system of claim 18, wherein the interface software is further configured to modify the displayable content of the plurality of viewpages based on inputs received via the page-based user interface.

20. The touch sensitive computing system of claim 18, wherein the interface software is further configured to search the displayable content of the plurality of viewpages based on a search index.
